(19) United States
(12) Patent Application Publication
(10) Pub. No.: US 2006/0104883 A1
(43) Pub. Date: May 18, 2006

(54) Method for treating materials containing free or chemically boundcarbon

(75) Inventors: Vladimir Rafeev, Imatra (FI); Jevgeni Kondra, Imatra (FI); Viktor Fursov, Imatra (FI)

Correspondence Address: MERCHANT & GOULD PC, P.O. BOX 2903, MINNEAPOLIS, MN, 55402-0903, US

(73) Assignee: Ekogastek, Imatra (FI)

(21) Appl. No.: 10/534,207

(22) PCT Filed: Nov. 8, 2002
(86) PCT No.: PCT/FI02/00878

§ 371 Date: Nov. 22, 2005

(51) Int. Cl. C01B 31/00

(52) U.S. Cl. 423/415.1

(57) ABSTRACT

The invention relates to the method and the apparatus for thermal processing of material containing free or chemically bound carbon, wherein the material is supplied into the reactor and gasifying agent containing oxygen is supplied counter currently with the supply of the material into the reactor, the zones of oxidizing and reduction are formed in the reactor. According to the invention the material is moved through the reactor and at least one flow-through channel is provided in the reactor, and the gasifying agent is supplied into the reactor and the product gas is withdrawn from the reactor by the channel which is arranged in a parallel direction with the movement of the material.

The present invention relates to a method and an apparatus as defined in the claims for thermal treating of materials containing free or chemically bound carbon by gasification to form product gas and carbon free solid residue.

In the disclosure such materials containing free or chemically bound carbon means materials of any origin, for example, fossil fuel (coal, peat, slates, bituminous sands, petroleum), industrial wastes (waste from coal mining or coal cleaning, fly ashes from thermoelectric power stations, wood waste products, waste products of biomass, waste products from oil refining, slurries, mechanical rubber wastes) or municipal waste products (sewage sludge, household rubbish). The proposed method allows to process a wide range of the materials which are essentially varying in composition and properties (powders, lumpy materials, paste-like materials, liquids) without attraction of specific preparation operations for different kinds of raw material.

Presently among known methods of thermal processing the gasification methods are considered as the most perspective ones (World Gasification Survey: Industry Trends & Developments. Presented by Dale Simbeck & Harry Johnson, SFA Pacific, Inc. at the Gasification Technologies 2001 Conference, Oct. 8, 2001, San Francisco, Calif.). At the same time current methods of gasification have a number of restrictions and lacks. In particular, to the applicant the industrial methods of gasification are unknown allowing without specialized preparation of raw material or addition to it of other materials to process materials in a paste-like condition, for example, oil-slurries, and bituminous sands. Processing of fine-dispersed materials, in particular fly ashes from thermoelectric power stations both in fluidized bed and in a fixed bed is also problematic. Processing flying ashes is not possible without tentative agglomeration (bricketing) in both cases: in a fluidized bed because of its ablation by a gas stream, and in a fixed bed because of the hydrodynamic resistance of the fine-dispersed powder.

Most similar method to the present invention is “Method for Treating Waste Material Containing Hydrocarbons” (PCT-FI9600466). This method allows to process materials containing more than 2% carbon with high ecological cleanliness and power efficiency. According to this method the applicant loaded in an experimental-industrial reactor-gasifier with a working diameter of 1500 mm (Toikansuo, Finland) a mixture of the worn out tires chopped up on pieces with an inert lumpy material and carried out the gasification by supplying in a reactor towards a fed material of a mixture of air and steam. The maximal temperature during processing was established in the middle part of the reactor where the zone of coke combusting is located. During research of gasification modes the applicant detected, that there can be situations when an increase of temperature in some sites of the combustion zone only slightly responds to an increase of steam supply.

Additional researches have shown that the possible reason of undesired increase of temperature during the oxidation of carbon contained in a gas-permeable material can be a phenomenon of the superadiabatic heating, arising in separate pieces of the material as a result of collision of exothermic transformation waves. This phenomenon is described in the literature for exothermic process of frontal polymerization (G. B. Manelis, Priroda, N 3-4 (1996) 43). During movement of the polymerization front from a surface of a cylindrical sample to the center a significant increase of temperature essentially exceeds the adiabatic heat observed at final stages of the process.

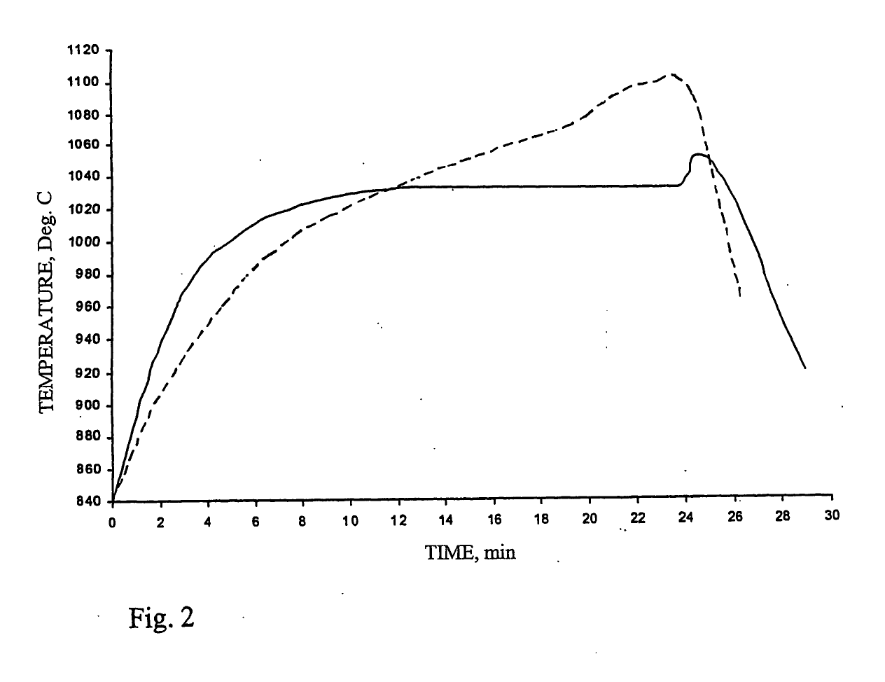

The applicant investigated combustion of the pressed cylindrical fly ash samples from the coal thermoelectric power station, containing 10% carbon in air stream heated to temperature 840□C. The temperature of a cylindrical sample having 27 mm diameter was measured by platinum-rhodium thermocouple on the axis of the sample, placing it soldered joint on a bottom of the hole drilled in a back end face of a sample on a depth of 20-25 mm. FIG. 2 describes the temperature of the sample (a) and (b), by length 55 and 170 mm, as function of time. It is visible, that at the end of the process of the sample combustion the temperature increases because of the superposition of the thermal waves going into the sample towards each other. Promotion of these waves could be observed visually on brightness of a luminescence of a surface of the end face of the sample. In the process of burning out carbon the luminous zone promoted from a lateral surface of the sample to its axis, forming a ring decreasing in diameter. At the end of the process the ring turned to a spectacular hot spot in the center of the back end face of the sample. The applicant never observed such wheating under test conditions when the wave of combustion was moved into a sample mainly in one direction, for example, during combustion the same fly ashes filled an equal layer in the tray. During processing in a reactor-gasifier the lumpy material having a sufficient ash content a similar phenomenon in conditions of the combustion zone can result in sintering several adjacent pieces of carbonized material, deterioration of uniformity of filtration through processed material and formation of areas with badly controllable high temperature in the combustion zone.

The object of the present invention is to eliminate the drawbacks of the prior art. The another object of the present invention is to provide a method and an apparatus, which allow to process a wide range of materials with essentially varying compositions and properties (powders, lumpy materials, paste-like materials, liquids) without specific preparation operations to each kind of raw material. A further object of the invention is to provide a method, which improve the controllability of the temperature modes of the process.

The method and apparatus of the invention are characterized by what is presented in the claims.

The invention is based on a method for processing of the material containing free or chemically associated carbon. The material is supplied the first end of the reactor and gasifying agent containing oxygen is supplied countercurrently with the supply of the material into the second end of the reactor, and the zones of oxidizing and reduction are formed in the reactor. At least a part of carbon of the material is oxidized by the gasifying agent at high temperature to form solid residue and gaseous reaction products in the oxidizing zone of the reactor and carbon dioxide formed as a result of the oxidation is at least partially reduced at high temperature in the reduction zone of the reactor. Formed product gas containing gaseous and possibly liquid reaction products is withdrawn from the first end of the reactor and the solid residue is discharged from the second end of the reactor. According to the invention the material is shaped before its supply into the reactor and the material is moved through the reactor from the first end of the reactor to the second end of the reactor during the processing. In the method at least one flow-through channel is provided in the reactor, and the gasifying agent is supplied into the reactor and the product gas is withdrawn from the reactor by the channel. The channel is arranged in a parallel direction with the movement of the material. The gasifying agent flows from the second end of the reactor into the material, between the parts of the material and/or between the material and an internal wall of the reactor and the product gas formed as a result of the processing is withdrawn out from the first end of the reactor. The channel is provided to ensure contact of the gasifying agent and/or the product gas with the material, and a minimum transverse size of the channel is not more than 1/100 from total length of the channel.

In an embodiment of the invention the minimum transverse size of the channel is not less than 5 mm.

In an embodiment of the invention the ratio between the summary cross-sectional area of the channel and the summary cross-sectional area of the material is within the limits from 0,05 to 3,0.

For averting undesirable local heating of the material and to increase controllability of temperature of the process one should make the material accessible for the gasifying agent only from one side, and for this purpose one can form several channels having elongated cross section and arranged essentially in parallel to each other and in which gasifying agent located in one adjacent channel of any channel pair can contact with a portion of the material located between these channels. The gasifying agent located in the second channel of this pair can not contact with this portion of the material, but can contact with the portion of material located on the opposite side of the second channel.

In an embodiment of the invention a pair of channels having elongated cross section are formed and arranged essentially parallel to each other, and the gasifying agent is supplied into the first channel of these adjacent channels which is in contact with a portion of the material located between these channels, and the gasifying agent which flows in the second channel of the pair is not in contact with said same portion of the material.

In an embodiment of the invention at least one channel is formed between the material and the internal wall of the reactor, and the material is loaded on the pallet.

In an embodiment of the invention one or several channels are formed between the portions of the material, and the portions of the material are loaded on the pallets which are located above with each other so that at least one channel is formed between each pallet and the material loaded on the adjacent underlying pallet.

In an embodiment of the invention the gas-impermeable pallets are used to eliminate the difficult controlled heating of the material. In order to make material accessible for the gasifying agent only from one side the gas-impermeable pallets are used

In an embodiment of the invention the gas-permeable pallets are used to guarantee the contact of the gasifying agent with the material through the pallets. When it is necessary to increase the maximum temperature of material in the reactor, one should ensure the access of the gasifying agent to the processed material from the different sides, placing the layers of material on the gas-permeable pallets.

In an embodiment of the invention the channel in the material can be formed by facing its walls of at least one solid article into which the material and/or the blocks of the material are entered.

In an embodiment of the invention the channel in the material also can be formed by the article with at least one flow-through channel.

In an embodiment of the invention at least portion of the product gas is withdrawn from reduction zone of the reactor in one or several places of this zone and at least portion of the fractions of the liquid products are separated from the product gas.

In an embodiment of the invention steam and/or carbon dioxide are supplied into the second end of the reactor.

The defined method of thermal processing of the materials containing free or chemically bound carbon, can be carried out by the apparatus which comprises a reactor, means for supplying the material into the first end of the reactor and, means for supplying a gasifying agent countercurrently with the supply of the material into the second end of the reactor, means for discharging the solid residue formed during the processing from the reactor and means for withdrawal of the product gas-containing gaseous and probably liquid products formed during the processing from the reactor. According to the invention a reactor is a tunnel furnace and the apparatus comprises means for moving the material through the reactor during the processing and at least one flow-through channel for providing the flow of the gasifying agent into the reactor and the flow of the product gas from the reactor and ensuring the contact of the gasifying agent and/or the product gas with the material so that the gasifying agent flows from the second end of the reactor into the material, between the parts of the material and/or between the material and an internal wall of the reactor and that the product gas formed as a result of the processing is withdrawn out from the first end of the reactor. The channel has been arranged in a parallel direction with the movement of the material provided by the means for moving the material, and minimum transverse size of the channel is not more than 1/100 from the length of the channel.

In an embodiment of the invention the means of supply and movement of the material comprise at least one platform for executing the movement of the material over the tunnel furnace and at least one pallet for placing the material on the pallet, and the pallet has been installed on the platform.

In an embodiment of the invention the pallets have been provided in the reactor so that at least one channel has formed between the material placed on the pallet and wall of the reactor or between each pallet and the material placed on the adjacent underlying pallet.

In an embodiment of the invention the tunnel furnace comprises rails for moving the material and the platforms which have wheels for moving along said rails.

In an embodiment of the invention the pallets are executed gas-impermeable for guaranteeing the supply of the gasifying agent to the processed material from one side.

In an embodiment of the invention the pallets are executed gas-permeable for guaranteeing the supply of the gasifying agent to the processed material from two sides.

In an embodiment of the invention the tunnel furnace comprises the additional means for withdrawal at least portion of the product gas, e.g. gaseous and possibly liquid products, from the tunnel furnace in one or several places. These means can contain means for separation of liquid products from the product gas.

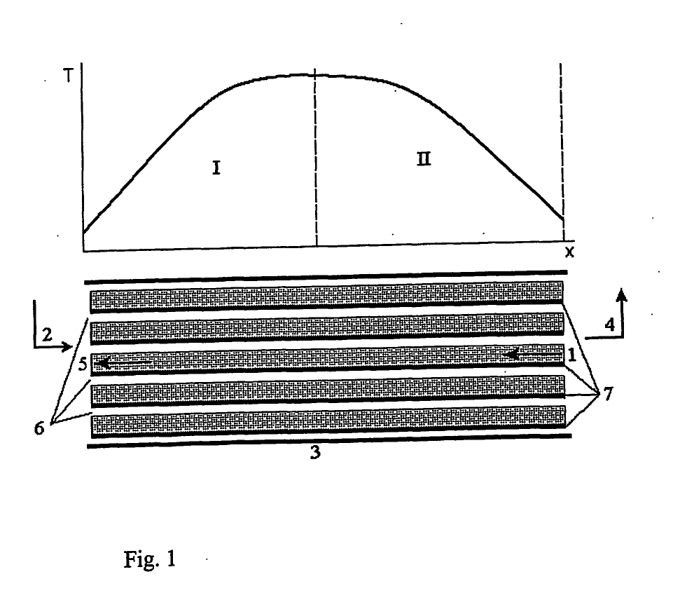

The schematic diagram of the process is shown in FIG. 1 and the approximate temperature distribution of the material along with the length of the reactor is given.

The experimental dependences, the temperature as function of time on the axis of two pressed cylindridal fly ash samples, which contain 10% carbon, during the oxidation in the airflow at a temperature of 840° C. are given in FIG. 2.

In the following, the invention is disclosed with reference to FIG. 1 showing a schematical diagram of the process, and also a description of the apparatus for the realization is given.

For implementing the treating, the process material (1) and the oxygen-containing gasifying agent (2) are supplied towards each other into the reactor (3) by a type of tunnel furnace with oxidizing (I) and reducing (II) regions. The regions are formed after the initiation of the process for example after placing the processed material to the platforms and after feeding them to the middle of the reactor where they ignite the material from the side of the supply of gasifying agent (2). It is possible to place on the first platform the highly inflammable fuel (firewood, peat, rags moistened by kerosene), that they ignite by any source of the free flame. As a result the ignition of material occurs.

After the ignition of the material in the reactor stationary temperature profile of the regions mentioned above is formed by continuously supplying the material and the gasifying agent towards each other. The form of the temperature profile, especially in the reducing region (II), depends on the origin of the processed material and technological conditions of the process; however, it preserves the main features shown in FIG. 1, namely, the presence of the zone with high temperature in the middle part of the reactor and its considerable decrease to the ends of the reactor. When the platform on which the ignition was accomplished passes from the middle of the reactor to the end, the withdrawal from the reactor of solid products from the processing (5) towards the supplied gasifying agent (2) is began simultaneously with the supply of material into the reactor. Air enriched either by oxygen or pure oxygen can be used as the gasifying agent.

The use of oxygen increases the productivity of the process and calorific value of the product gas but complicates apparatus and the safety of the production is decreased. For controlling the temperature conditions of the process steam and/or carbon dioxide are introduced into gasifying agent (2). Oxygen is supplied into the reactor in a quantity, which is not sufficient for the complete oxidation of carbon contained in the processed material, and as a result the oxygen is completely consumed in the oxidizing region (I) predominantly in the middle part of the reactor in the zone of maximum temperatures. Thus, by the oxidizing region (I) the applicant implies that the region of the reactor in which gaseous oxygen is not yet completely spent by the oxidation of carbon and its concentration exceeds thermodynamically equilibrium value.

Oxygen practically is absent downstream along the flow of gas in the reactor, the reducing region (II) is located here in which predominantly reducing reactions occur and also depending on the origin of the processed material the processes of cooking, pyrolysis, cracking take place certainly, chemical reactions in both regions of the reactor occur only under comparatively high temperatures and in the presence of the corresponding reagents. In particular, the oxidizing region (I) includes both located predominantly in the middle part of the reactor in the zone where the carbon oxidation reactions occur and in the zone at the end of the reactor on the side where the supply of gasifying agent (2) occur and where carbon is absent (already completely reacted), and only the processes of heat exchange between the gasifying agent (2) and the solid products of the processing (5) proceed.

The supplied gasifying agent recovers the sensible heat of hotter solid residue in this zone, as a result of this it returns the heat into the high-temperature zone of the oxidizing region (I) which contains carbon where it enters in the reaction and where the carbon is preliminarily heated. The collection of the processes, which take place in the reducing region of the reactor (II), depends not only on the temperature but also on the nature of the material. For example, during processing of fly ashes or some other material which contains only free carbon, the reactions of the gasification of carbon by steam and by carbon dioxide occur near the middle of the reactor in the high-temperature zone of the reducing region (II) and nearer toward the end of the reactor only heat exchange occurs between product gas (4) withdrawn from it and colder material (1) supplied towards it at comparatively low temperatures.

The result of this heat exchange is analogously described above for the oxidizing region of the reactor the recovery of heat into the zone of high temperatures. The difference is only in the fact that the heat is transferred to the middle part of the reactor by the flow of gas phase in the oxidizing zone and by flow of the condensed phase in the reducing one. Thus, heat exchange between the condensed and the gas phase under the conditions of their countercurrent in both regions of the reactor even in the absence of special heat exchangers provides internal heat regeneration and makes it possible to achieve a high conversion effectiveness of the heat combustion of the source material into the heat combustion of the product gas obtained. Balanced flows of the processed material and gasifying agent create conditions for withdrawal of both the solid residue and the product gas from the reactor at relatively low temperatures that decreases heat losses and increases the energy efficiency of the process.

During the processing of materials containing chemically bound carbon and moisture the collection of the processes which take place in the region (II) is more wide. The physical processes of evaporation and condensation predominate at the end of the reactor in the zone of low temperatures. The drying of material here occurs if it moist and also the evaporation of other volatile components, for example, the low-molecular fractions of hydrocarbons and other organic compounds in the material. Simultaneously the low-volatile components are condensed in this zone which were evaporated or were formed in the region (II) nearer to the middle of the reactor at higher temperatures upstream the flow of gas, for example, pyrolysis tars or the heavy fractions of petroleum. During the condensation they form a predominantly highly dispersed fog, which is withdrawn from the reactor within the product gas (4). The processes of the thermal transformations of the carbon-containing components (pyrolysis, cracking, cooking) are included since the processed material moves to the middle of the reactor into the zone of higher temperatures, as a result gas flow is enriched in volatile products and processed material is converted into the semicoke and the coke. Further the zone of gasification is placed in which the incandescent coke reacts with the steam and/or the carbon dioxide introduced into the gasifying agent, and as a result gas flow is enriched in hydrogen and carbon mono-oxide. The same endothermic reactions occur also in the high-temperature zone of oxidizing region (I), where the exothermic oxidation reactions of carbon into mono-oxide and carbon dioxide take place simultaneously.

Operating with a quantity of steam and/or carbon dioxide introduced into the gasifying agent it is possible to change the yield of exothermic and endothermal reactions in the zone of maximum temperatures and thus to control the temperature conditions of the process. When neither steam nor carbon dioxide is introduced into the composition of the gasifying agent controlling the temperature conditions of the process can be accomplished by regulation of the oxygen content in the gasifying agent, for example, by the enrichment of air by oxygen or by the dilution of it by inert gas. In this case the coke in the oxidizing region reacts predominantly with oxygen while in the reducing region only with carbon dioxide formed as a result of this reaction.

In the implementation of a similar process of processing in the reactor of the type of shaft kiln in the packed bed it is not practically possible to process the materials which contain large quantities of trifle since it is impossible to ensure an uniform filtration of gas flow throughout the entire cross section of the reactor. It is also difficult to create uniform permeability of semi-fluid paste-like materials like petroleum sludge or, for example, bituminous sands.

According to the method the proposed material (1) is shaped before its supply in the reactor and the material is moved through the reactor from the first end of the reactor to the second end of the reactor during the processing. In the method at least one flow-through channel (6) is provided in the reactor, and the gasifying agent (2) is supplied into the reactor and the product gas is withdrawn from the reactor by the channel. The channel is arranged in a parallel direction with the movement of the material. The gasifying agent flows from the second end of the reactor into the material, between the parts of the material and/or between the material and an internal wall of the reactor and the product gas formed as a result of the processing is withdrawn out from the first end of the reactor. The channel is provided to ensure contact of the gasifying agent and/or the product gas with the material.

Gas flow at the channel inlet is gasifying agent (2), further along the length of the reactor due to the heat-mass exchange with the surface of the processed material it is enriched inside the channel in gaseous products of chemical conversions being converted into the product gas (4) at the other end of the reactor.

This structure of channels ensures the uniform and regular distribution of gas flow over the cross section of the reactor removing deficiencies of the methods of gasification in the packed bed connected with the difficulty guarantees of uniform permeability of a charge. This difficulty is inherent in the methods of gasification in the packed bed because of the fact that the chaotic structure of the channels arising in the material in the course of the process is weakly controlled and can lead to the formation of burnouts and badly air-blast regions which impair the characteristics of the process or even need to stop it.

The extent of zones inside the reactor depends on the determinative transverse size of the channels (6), determining intensity of the heat-mass transfer between the gas flow and the surface of the processed material. For the channel, which has the cross section of rectangular form or close to it—this is the minimal transverse size. Its decrease with the maintaining of the flow rates of the gasifying agent and summary cross-sectional area of channels leads to the intensification of the processes of the heat-mass transfer between the gas and that condensed phase inside the reactor since increases the specific surface area of the working volume of the reactor through which the layers of the processed material are exchanged with the gas the flows of heat and mass which appear as a result of chemical transformations.

This makes it possible to reduce the extent of zones in the reactor and thus to decrease the length of the tunnel. On the contrary, an increase in the size leads to the expansion of said zones. Therefore, for the reactor of a defined length and productivity there is a limitation from above that the minimum transverse size of the channel connected with the fact that the structure of zones mentioned cannot be placed inside the reactor since oxygen of the gasifying agent will not manage completely to be consumed during the oxidation of carbon which will lead to both the sharp reduction in the calorific value of the product gas and to the risk of obtaining inflammable-explosive product gas into composition of which will enter both combustible gases and oxygen. This actually will lead to the degeneration of a reducing zone inside the reactor and therefore to the impossibility of the realization of the declared process in the reactor of this length. The appearance of incompletely burned carbon in the solid residue can be another negative consequence of the excessively high value of the minimum transverse size of the channel. The point is that the value of diffusion flow of oxygen to the surface of the material layer decreases with an increase in the minimum transverse size of the channel due to a drop in the concentration gradient of oxygen across the channel. As a result the diffusion flow of oxygen is not sufficient for a complete oxidation of the carbon during retention time in the oxidizing zone and unburned carbon will appear in the solid residue. In order to avoid negative consequences of excessively large transverse sizes of channels mentioned above the minimum transverse size of the channel is assigned not more than 1/100 from the total path length of gas flow along the channel in the reactor. At the same time small dimensions of the cross section of channels increase the hydrodynamic drag of the reactor and a pressure drop in the charge. For this reason the minimum transverse sizes of channels (6) establish preferably not less than 5 mm. Pressure drop becomes too great using smaller sizes of the channels which leads to reduction in the productivity of the reactor or it requires the application of compressors instead of the fans for guaranteeing a sufficient consumption of the gasifying agent. Another reason for this limitation of minimal size of the channels is the excessive growth of a quantity of layers of material per unit of the cross-sectional area of the reactor, which is not technologically effective since it strongly complicates the operations of loading and discharging the platforms.

The ratio between the summary cross-sectional area of the channels and the summary cross-sectional area of the material is assigned preferably within the limits from 0,05 to 3,0. The decrease of this relation lower than 0,05 with the retention of determining the productivity of the reactor of a constant flow rate of the gasifying agent for the unit of the area of its cross section leads to a considerable growth of the velocity of gas flow in the channels, which is undesirable because of the capture of dust by product gas flow. An increase in this relation makes it possible to raise the specific productivity of the reactor in the absence of large amount of fly ash to values, which exceed the specific productivity of the fluidized bed gasifiers. However to increase this relation higher than 3,0 is not expedient since the layers of the material will occupy less than fourth cross section of the reactor, and substantially will grow the speed of the movement of material over the reactor. In this case theoretically it is possible to raise the productivity of the reactor maximum to fourth, but this is practically difficult to carry out because of the limitation from above the feed rate of platforms into the reactor with the speeds of the load of material to the platforms and discharging solid residue from them.

To increase the temperature controllability of the process when necessary to avoid difficult controllable material heating in encounter combustion waves it is necessary to ensure access of oxygen to the material only from one side for which one can form several channels with elongated cross section and arranged approximately in parallel to each other and in which gasifying agent located in one adjacent channel from any pair can contact with portion of processed material located between these channel and the second channel of this pair and gasifying agent located in indicated second channel can not contact with this portion of processed material, but can contact with portion of processed material located on opposite side of indicated second channel.

One or several channels of necessary forms and sizes can be formed either between the material and the internal wall of the reactor by arrangement on the pallets or between the portions of the processed material by arranging these portions on the pallets located above each other with the formation between each pallet and processed material placed on the adjacent underlying pallet the gap which forms one of the channels mentioned.

Placing the processed material on the gas-impermeable pallets for eliminating the difficulty controlled heating of the material in the encountered waves of combustion.

For guaranteeing the contact of the gasifying agent with the processed material through pallets it is placed on the gas-permeable pallets. This is needed when it is necessary to increase the temperature of material in the region of the reactor with the maximum temperature, for example, for the kilning of the solid products, or in the case of insufficient calorific value of source material. The arrangement of processed material on the gas-permeable pallets (for example, netting, or having apertures) provides conditions for the appearance of the effect of its heating in the encountered waves of combustion.

Analogous conditions can also be created by facing walls of the channels mentioned in the processed material from the solid objects entering the processed material and/or the blocks pressed from the processed material.

The mentioned channels in the processed material can be also formed, placing the material into the articles which have flow-through channels. To ensure contact of gas located in the channel with material the walls of the channel are gas-permeable. Said articles may be containers into which the material are placed before its supply into the reactor.

The invention proposed with the arrangement of material layers on the pallets has an important advantage in comparison with other known methods of gasification because it provides the possibility to process a wide spectrum of materials which are essentially distinguished in composition and properties without the attraction of specific preparation operations for each form of the raw material (powders, lump, paste-like and even liquid materials). Material only must be loaded by uniform layers to the pallets.

During the processing by the declared method of materials like petroleum which contain much volatile organic matter it is possible to accomplish a preliminary rectification of the part of the resultant liquid products. For this purpose a portion of the product gas is withdrawn from reduction zone of the reactor in one or several places of this zone and the appropriate fractions of the liquid products are separated from the gas. In this case predominantly more or less volatile components (for example, the more or less light fractions of petroleum) will be obtained depending on the temperature at which the flow of gas will be withdrawn from the reactor.

Method declared of thermal processing of the materials containing free or chemically bound carbon, can be carried out by the apparatus which comprises a reactor, means for supplying the material into the first end of the reactor and, means for supplying a gasifying agent countercurrently with the supply of the material into the second end of the reactor, means for discharging the solid residue formed during the processing from the reactor and means for withdrawal of the product gas containing gaseous and probably liquid products formed during the processing from the reactor.

Reactor is a tunnel furnace and the means of supply and movement of the material are executed so as to prevent the entry of air into the tunnel and its mixing with the product gas and to ensure creation in the material either between its portions or between material and the arch of the furnace of a one or more flow-through channels, which have minimum transverse size not more than 1/100 from the length of the tunnel, oriented predominantly along the direction of the movement of the material over the reactor and executed with the possibility of guaranteeing the contact of the gasifying agent and/or product gas located in them with the processed material.

The means of supply and movement of the material can contain the platforms executed with the possibility of their movement over the tunnel furnace and the pallets for the placing on them of the material, installed on the platforms or above with each other on each platform with the possibility of formation between material and the arch of the furnace or between each pallet and the material placed on the adjacent underlying pallet the gap which forms one of the channels indicated.

The tunnel furnace has rails for moving the material, and the platforms have wheels for moving over the rails indicated.

The pallets are executed gas-impermeable for eliminating the difficult controlled heating of the material in the encountered waves of combustion.

The pallets are executed gas-permeable for guaranteeing the contact of the gasifying agent with the material through the pallets.

In the case of processing materials like petroleum, which contain much volatile organic material, for the realization of the preliminary rectification of the part of the resultant liquid products tunnel furnace is executed with the additional means of withdrawal from it gaseous and possibly liquid products of the process located in one or several places up to an output of the product gas from the tunnel. These means contain means for separation of the liquid products.

The embodiments of the invention are not restricted to the examples presented above; instead, they may be varied within the scope of the claims below.

1. A method for thermal processing of material containing free or chemically bound carbon, wherein the material is supplied into the first end of the reactor and gasifying agent containing oxygen is supplied countercurrently with the supply of the material into the second end of the reactor, the zones of oxidizing and reduction are formed in the reactor, and at least a part of carbon of the material is oxidized by the gasifying agent at high temperature to form solid residue and gaseous reaction products in the oxidizing zone of the reactor and carbon dioxide formed as a result of the oxidation is at least partially reduced at high temperature in the reduction zone of the reactor, formed product gas containing gaseous and possibly liquid reaction products is withdrawn from the first end of the reactor and the solid residue is discharged from the second end of the reactor, wherein the material is shaped before its supply into the reactor and the material is moved through the reactor from the first end of the reactor to the second end of the reactor during the processing, at least one flow-through channel is provided in the reactor, and the gasifying agent is supplied into the reactor and the product gas is withdrawn from the reactor by the channel which is arranged in a parallel direction with the movement of the material so that the gasifying agent flows from the second end of the reactor into the material, between the parts of the material and/or between the material and an internal wall of the reactor and that the product gas formed as a result of the processing is withdrawn out from the first end of the reactor, and the channel is provided to ensure contact of the gasifying agent and/or the product gas with the material, and a minimum transverse size of the channel is not more than 1/100 from total length of the channel.

2. A method according to claim 1, wherein the minimum transverse size of the channel is not less than 5 mm.

3. A method according to claim 1, wherein the ratio between the summary cross-sectional area of the channel and the summary cross-sectional area of the material is within the limits from 0,05 to 3,0.

4. A method according to claim 1, wherein a pair of channels having elongated cross section are formed and arranged essentially parallel to each other, and the gasifying agent is supplied into the first channel of these adjacent channels which is in contact with a portion of the material located between these channels, and the gasifying agent which flows in the second channel of the pair is not in contact with said same portion of the material.

5. A method according to claim 1, wherein at least one channel is formed between the material and the internal wall of the reactor, and the material is loaded on the pallet.

6. A method according to claim 1, wherein one or several channels are formed between the portions of the material, and the portions of the material are loaded on the pallets which are located above with each other so that at least one channel is formed between each pallet and the material loaded on the adjacent underlying pallet.

7. A method according to claim 5 wherein the gas-impermeable pallets are used.

8. A method according to claim 5 wherein the gas-permeable pallets are used to guarantee the contact of the gasifying agent with the material.

9. A method according to claim 1, wherein said channel is formed by facing its walls of at least one solid article into which the material and/or the blocks of the material are entered.

10. A method according to claim 1, wherein said channel is formed by the article with at least one flow-through channel.

11. A method according to claim 10, wherein said material is loaded into the article which has at least one flow-through channel.

12. A method according to claim 1, wherein at least portion of the product gas is withdrawn from reduction zone of the reactor in one or several places of this zone and at least portion of fractions of the liquid products are separated from the product gas.

13. A method according to claim 1, wherein steam and/or carbon dioxide are supplied into the second end of the reactor.

14. Apparatus for thermal processing of material containing free or chemically bound carbon, said apparatus comprising a reactor (3), means for supplying the material (1) into the first end of the reactor and, means for supplying a gasifying agent (2) countercurrently with the supply of the material into the second end of the reactor, means for discharging the solid residue (5) formed during the processing from the reactor and means for withdrawal of the product gas (4) containing gaseous and probably liquid products formed during the processing from the reactor, wherein said reactor (3) is a tunnel furnace and the apparatus comprises means (7) for moving the material (1) through the reactor during the processing and at least one flow-through channel (6) for providing the flow of the gasifying agent (2) into the reactor and the flow of the product gas (4) from the reactor and ensuring the contact of the gasifying agent (2) and/or the product gas (4) with the material (1) so that the gasifying agent (2) flows from the second end of the reactor into the material, between the parts of the material and/or between the material and an internal wall of the reactor and that the product gas (4) formed as a result of the processing is withdrawn out from the first end of the reactor, and channel (6) has been arranged in a parallel direction with the movement of the material provided by the means (7) for moving the material, and minimum transverse size of the channel is not more than 1/100 from the length of the channel.

15. Apparatus according to claim 14, wherein the means of supply and movement of the material comprise at least one platform for executing the movement of the material over the tunnel furnace and at least one pallet (7) for placing the material (1) on the pallet, and the pallet has been installed on the platform.

16. Apparatus according to claim 15, wherein the pallets (7) have been provided in the reactor so that at least one channel (6) has formed between the material placed on the pallet (7) and wall of the reactor or between each pallet (7) and the material (1) placed on the adjacent underlying pallet.

17. Apparatus according to claim 15, wherein the tunnel furnace comprises rails for moving the material and the platforms which have wheels for moving along said rails.

18. Apparatus according to claim 15, wherein the pallets (7) are gas-impermeable.

19. Apparatus according to claim 15, wherein the pallets (7) are gas-permeable.

20. Apparatus according to claim 14, wherein the tunnel furnace comprises the additional means for withdrawal at least portion of the product gas from the tunnel furnace in one or several places.

21. Apparatus according to claim 20, wherein said additional means comprise means for separation of liquid products from the product gas.
